(19) United States
(12) Patent Application Publication
(10) Pub. No.: US 2021/0377647 A1
(43) Pub. Date: Dec. 2, 2021

(54) Headphones Workstation Assembly

(71) Applicants: Nicolette Reece, Copperas Cove, TX (US); Marcus Gibson, Cooperas Cove, TX (US)

(72) Inventors: Nicolette Reece, Copperas Cove, TX (US); Marcus Gibson, Cooperas Cove, TX (US)

(21) Appl. No.: 16/885,612

(22) Filed: May 28, 2020

(51) Int. Cl. H04R 1/10; G06F 3/16

(52) U.S. Cl. CPC H04R 1/1041; H04R 2420/07; G06F 3/162; H04R 1/1025

(57) ABSTRACT

A headphones workstation assembly includes a pair of headphones that is wearable on a user. A microphone is coupled to and extends across the headphones to record audible sounds. An audio workstation is integrated into the headphones to record the audible sounds captured by the microphone. A first touch screen is coupled to a respective one of the headphones and the first touch screen displays indicia comprising operational icons and words pertaining to the audio workstation. A sound processor is integrated into the headphones for producing music that can be recorded into the audio workstation. A second touch screen is coupled to a respective one of the headphones and the second touch screen displays indicia comprising operational icons and words pertaining to the sound processor.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to workstation devices and more particularly pertains to a new workstation device for recording and editing music with a pair of headphones.

### (2) Description of Related Art Including Information Disclosed Under 37 CFR 1.97 and 1.98

The prior art relates to workstation devices including a pair of headphones with wireless communication for wirelessly integrating with speech recognition software. The prior art also discloses a variety of headphones that have wireless internet access and an electronic display. The prior art also discloses a pair of headphones that can mix audible sounds from a plurality of sources. The prior art also discloses a pair of headphones and a phone case that has a microphone preamplifier embedded therein. The prior art also discloses a variety of headphones that include digital audio storage and touch screen displays.

### BRIEF SUMMARY OF THE INVENTION

An embodiment of the disclosure meets the needs presented above by generally comprising a pair of headphones that is wearable on a user. A microphone is coupled to and extends across the headphones to record audible sounds. An audio workstation is integrated into the headphones to record the audible sounds captured by the microphone. A first touch screen is coupled to a respective one of the headphones and the first touch screen displays indicia comprising operational icons and words pertaining to the audio workstation. A sound processor is integrated into the headphones for producing music that can be recorded into the audio workstation. A second touch screen is coupled to a respective one of the headphones and the second touch screen displays indicia comprising operational icons and words pertaining to the sound processor.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a headphones workstation assembly according to an embodiment of the disclosure.

FIG. 2 is a right side view of an embodiment of the disclosure.

FIG. 3 is a left side view of an embodiment of the disclosure.

FIG. 4 is a cross sectional view taken along line 4-4 of FIG. 1 of an embodiment of the disclosure.

FIG. 5 is a schematic view of an embodiment of the disclosure.

### DETAILED DESCRIPTION OF THE INVENTION

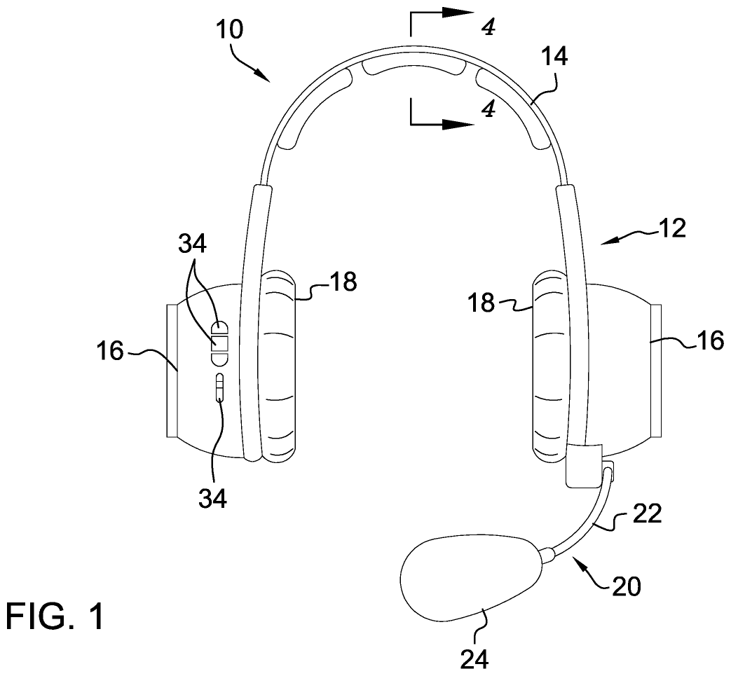

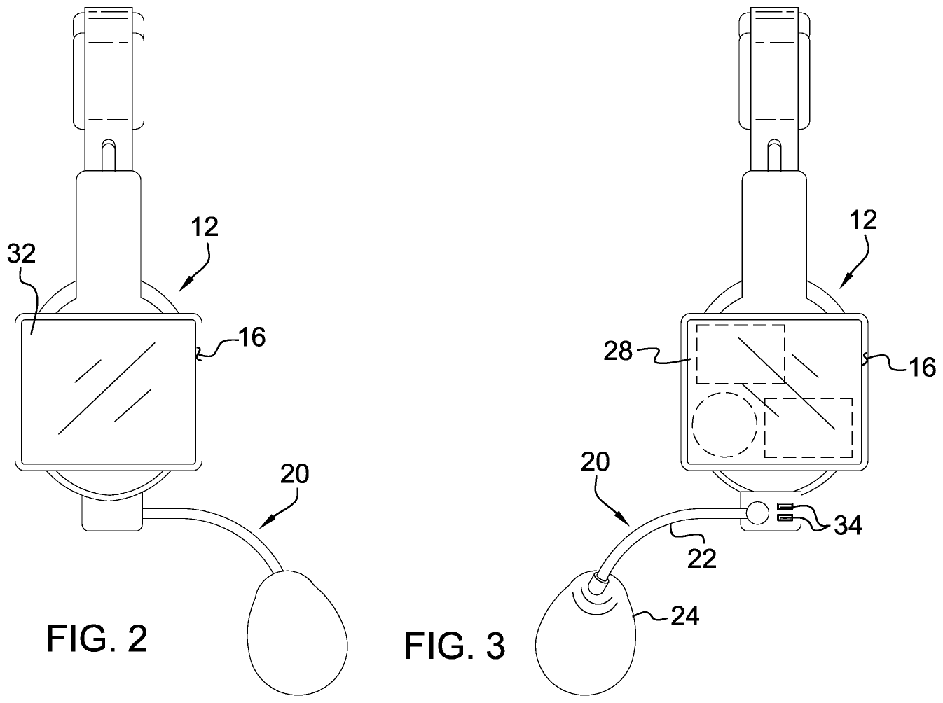

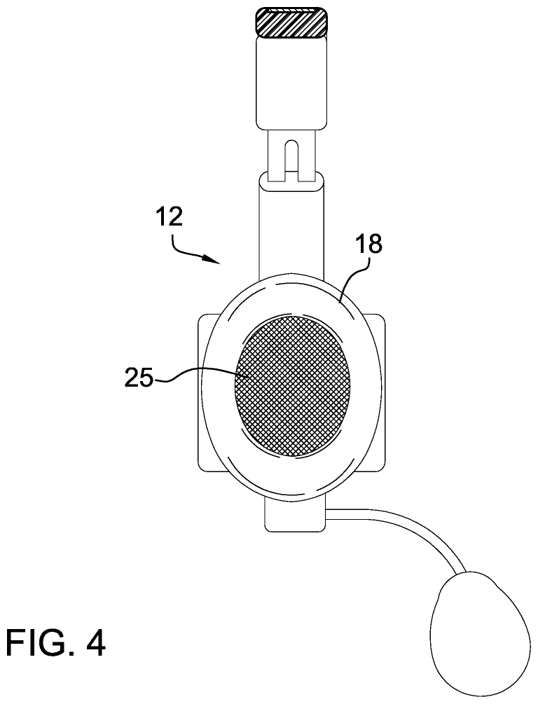

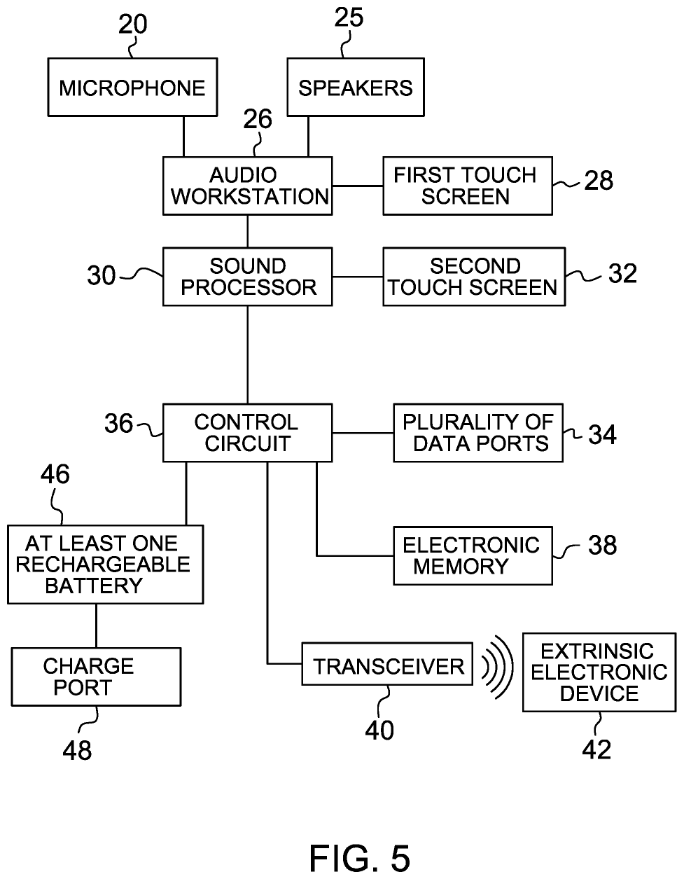

With reference now to the drawings, and in particular to FIGS. 1 through 5 thereof, a new workstation device embodying the principles and concepts of an embodiment of the disclosure and generally designated by the reference numeral 10 will be described.

As best illustrated in FIGS. 1 through 5, the headphones workstation assembly 10 generally comprises a pair of headphones 12 that are wearable on a user. The headphones 12 include a bridge 14 extending between the headphones 12 for extending across the user's head when the headphones 12 are worn. Each of the headphones 12 has an outward surface 16 and the outward surface 16 on each of the headphones 12 is directed away from each other. Each of the headphones 12 includes a cushion 18 for enhancing comfort of the user's ears. A microphone 20 is coupled to and extends across the headphones 12 to record audible sounds, and the microphone 20 includes a flexible arm 22 and a mouthpiece 24. The headphones 12 include a pair of speakers 25 that are each directed toward the user's ears when the headphones 12 are worn.

An audio workstation 26 is integrated into the headphones 12. The microphone 20 is in electrical communication with the audio workstation 26 thereby facilitating the audio workstation 26 to record the audible sounds captured by the microphone 20. Additionally, the audio workstation 26 stores operational software comprising music recording and editing software. The audio workstation 26 may include components and have capabilities similar to that of existing digital audio workstations.

A first touch screen 28 is coupled to a respective one of the headphones 12 such that the first touch screen 28 can be manipulated by the user. The first touch screen 28 is in electrical communication with the audio workstation 26. Additionally, the first touch screen 28 displays indicia comprising operational icons and words pertaining to the audio workstation 26. The first touch screen 28 is positioned on the outward surface 16 of the respective headphone 12. Additionally, the first touch screen 28 may comprise a LCD or other similar electronic display.

A sound processor 30 is integrated into the headphones 12 and the sound processor 30 is in communication with the audio workstation 26. The sound processor 30 includes a MIDI interface, a drum machine and a synthesizer. In this way the sound processor 30 can produce music that can be recorded into the audio workstation 26. Additionally, the sound processor 30 stores operational software comprising music production software. The sound processor 30 may include components and have capabilities similar to those of existing instrument emulators, drum machines and MIDI interface devices.

A second touch screen 32 is coupled to a respective one of the headphones 12 for being manipulated by the user. The second touch screen 32 is in electrical communication with the sound processor 30. Additionally, the second touch screen 32 displays indicia comprising operational icons and words pertaining to the sound processor 30. The second touch screen 32 is positioned on the outward surface 16 of the respective headphone 12. The second touch screen 32 may comprise an LCD or other similar type of electronic display.

A plurality of data ports 34 is provided and each of the data ports 34 is integrated into the headphones 12. Each of the data ports 34 is in electrical communication with the audio workstation 26 and the sound processor 30 for sending and receiving data between the headphones 12 and external processing equipment. The plurality of data ports 34 may include usb ports, micro usb ports, midi ports, ¼ stereo ports and other type of digital data ports.

A control circuit 36 is integrated into the headphones 12 and the control circuit 36 is electrically coupled to the audio workstation 26, the sound processor 30 and each of the data ports 34. An electronic memory 38 is integrated into the headphones 12. The electronic memory 38 is electrically coupled to the control circuit 36 for storing music data produced by the electronic workstation and the sound processor 30. A transceiver 40 is integrated into the headphones 12 and the transceiver 40 is electrically coupled to the control circuit 36. The transceiver 40 is in wireless communication with an extrinsic electronic device 42 for sending data between the control circuit 36 and the extrinsic electronic device 42. The transceiver 40 may be a radio frequency transceiver or the like. Additionally, the transceiver 40 may employ a WPAN signal and Bluetooth communication protocols.

A power supply 44 is integrated into the headphones 12 and the power supply 44 is electrically coupled to the headphones 12, the audio workstation 26, the sound processor 30 and the microphone 20. The power supply 44 comprises at least one rechargeable battery 46 that is integrated into the headphones 12 and the at least one rechargeable battery 46 is electrically coupled to the control circuit 36. A charge port 48 is recessed into the headphones 12 to receive a charge cord from a power source. The charge port 48 is electrically coupled to the at least one rechargeable battery 46 for charging the at least one rechargeable battery 46.

In use, the headphones 12 are worn when the user wishes to record vocals on an audio track or other type of vocal recording. Each of the first touch screen 28 and the second touch screen 32 are manipulated to record and edit the vocals with the audio workstation 26 and the sound processor 30. In this way, any musical ideas the user may have can be captured at any time or location. Additionally, any music that is recorded on the headphones 12 can be transferred into a traditional digital audio workstation, via the transceiver 40 or the data ports 34, for further editing and processing.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A headphones workstation assembly for recording and mixing music, said assembly comprising:
a pair of headphones that is wearable on a user, said headphones including a bridge extending between said headphones for extending across the user's head when said headphones are worn;
a microphone being coupled to and extend across said headphones wherein said microphone is configured to record audible sounds;
an audio workstation being integrated into said headphones, said microphone being in electrical communication with said audio workstation thereby facilitating said audio workstation to record the audible sounds captured by said microphone;
a first touch screen being coupled to a respective one of said headphones wherein said first touch screen is configured to be manipulated by the user, said first touch screen being in electrical communication with said audio workstation, said first touch screen displaying indicia comprising operational icons and words pertaining to said audio workstation;
a sound processor being integrated into said headphones, said sound processor being in communication with said audio workstation, said sound processor including a MIDI interface, a drum machine and a synthesizer for producing music that can be recorded into said audio workstation; and
a second touch screen being coupled to a respective one of said headphones wherein said second touch screen is configured to be manipulated by the user, said second touch screen being in electrical communication with said sound processor, said second touch screen displaying indicia comprising operational icons and words pertaining to said sound processor.

2. The assembly according to claim 1, wherein:
each of said headphones has an outward surface, said outward surface on each of said headphones being directed away from each other;
said first touch screen is positioned on said outward surface of said respective headphone; and
said second touch screen is positioned on said outward surface of said respective headphone.

3. The assembly according to claim 1, further comprising a plurality of data ports, each of said data ports being integrated into said headphones, each of said data ports being in electrical communication with said audio workstation and said sound processor for sending and receiving data between said headphones and external processing equipment.

4. The assembly according to claim 3, further comprising a control circuit being integrated into said headphones, said control circuit being electrically coupled to said audio workstation, said sound processor and each of said data ports.

5. The assembly according to claim 4, further comprising an electronic memory being integrated into said headphones, said electronic memory being electrically coupled to said control circuit for storing music data produced by said. electronic workstation and said sound processor.

6. The assembly according to claim 4, further comprising a transceiver being integrated into said headphones, said transceiver being electrically coupled to said control circuit, said transceiver being in wireless communication with an extrinsic electronic device for sending data between said control circuit and the extrinsic electronic device.

7. The assembly according to claim 4, further comprising a power supply being integrated into said headphones, said power supply being electrically coupled to said headphones, said audio workstation, said sound processor and said microphone, said power supply comprising:
at least one rechargeable battery being integrated into said headphones, said at least one rechargeable battery being electrically coupled to said control circuit; and
a charge port being recessed into said headphones wherein said charge port is configured to receive a charge cord from a power source, said charge port being electrically coupled to said at least one rechargeable battery for charging said at least one rechargeable battery.

8. A headphones workstation assembly for recording and mixing music, said assembly comprising:
a pair of headphones that is wearable on a user, said headphones including a bridge extending between said headphones for extending across the user's head when said headphones are worn, each of said headphones having an outward surface, said outward surface on each of said headphones being directed away from each other, each of said headphones including a cushion for enhancing comfort of the user's ears;
a microphone being coupled to and extend across said headphones wherein said microphone is configured to record audible sounds, said microphone including a flexible arm and a mouthpiece;
an audio workstation being integrated into said headphones, said microphone being in electrical communication with said audio workstation thereby facilitating said audio workstation to record the audible sounds captured by said microphone, said audio workstation storing operational software comprising music recording and editing software;
a first touch screen being coupled to a respective one of said headphones wherein said first touch screen is configured to be manipulated by the user, said first touch screen being in electrical communication with said audio workstation, said first touch screen displaying indicia comprising operational icons and words pertaining to said audio workstation, said first touch screen being positioned on said outward surface of said respective headphone;
a sound processor being integrated into said headphones, said sound processor being in communication with said audio workstation, said sound processor including a MIDI interface, a drum machine and a synthesizer for producing music that can be recorded into said audio workstation, said sound processor storing operational software comprising music production software;
a second touch screen being coupled to a respective one of said headphones wherein said second touch screen is configured to be manipulated by the user, said second touch screen being in electrical communication with said sound processor, said second touch screen displaying indicia comprising operational icons and words pertaining to said sound processor, said second touch screen being positioned on said outward surface of said respective headphone;
a plurality of data ports, each of said data ports being integrated into said headphones, each of said data ports being in electrical communication with said audio workstation and said sound processor for sending and receiving data between said headphones and external processing equipment;
a control circuit being integrated into said headphones, said control circuit being electrically coupled to said audio workstation, said sound processor and each of said data ports;
an electronic memory being integrated into said headphones, said electronic memory being electrically coupled to said control circuit for storing music data produced by said electronic workstation and said sound processor;
a transceiver being integrated into said headphones, said transceiver being electrically coupled to said control circuit, said transceiver being in wireless communication with an extrinsic electronic device for sending data between said control circuit and the extrinsic electronic device;
a power supply being integrated into said headphones, said power supply being electrically coupled to said headphones, said audio workstation, said sound processor and said microphone, said power supply comprising:
at least one rechargeable battery being integrated into said headphones, said at least one rechargeable battery being electrically coupled to said control circuit; and
a charge port being recessed into said headphones wherein said charge port is configured to receive a charge cord from a power source, said charge port being electrically coupled to said at least one rechargeable battery for charging said at least one rechargeable battery.
